(19) United States
(12) Patent Application Publication
(10) Pub. No.: US 2025/0368795 A1
(43) Pub. Date: Dec. 4, 2025

(54) SYSTEM AND METHOD FOR RECOVERING BITUMEN, GRANULES, AND LIMESTONE FILLERS FROM USED ASPHALT SHINGLES

(71) Applicant: Redivius, LLC, Jeffersonville, IN (US)

(72) Inventors: Huy Huynh, Goshen, KY (US); William Lawrence, Louisville, KY (US); Dustin French, Louisville, KY (US); Steve Ragan, Louisville, KY (US); Shawn Anderson, Jeffersonville, IN (US); Joseph Ayden Huynh, Goshen, KY (US)

(21) Appl. No.: 19/221,029

(22) Filed: May 28, 2025

Related U.S. Application Data
(60) Provisional application No. 63/652,454, filed on May 28, 2024.

(51) Int. Cl. C08J 11/08; B03B 9/02; C10C 3/06

(52) U.S. Cl. CPC C08J 11/08; B03B 9/02; C10C 3/06; C08J 2395/00

(57) ABSTRACT

A system for recovering bitumen, granules, and limestone fillers from asphalt shingles includes: a mixer; a filter; a first dryer; a centrifuge; a second dryer; and a distillation unit. The mixer receives and mixes asphalt shingles and a solvent to produce a slurry. The filter processes the slurry to generate a cake material and a filtrate. The cake material is received and heated by the first dryer to isolate a first constituent of the asphalt shingles. The filtrate is received and separated by the centrifuge into a first phase material and a second phase material. The first phase material is received and heated by the second dryer to isolate a second constituent of the asphalt shingles. The second phase material is processed by the distillation unit to isolate a third constituent of the asphalt shingles. A method for recovering bitumen, granules, and limestone fillers from asphalt shingles is also disclosed.

### CROSS-REFERENCE TO RELATED APPLICATION

The present application claims priority to U.S. Patent Application Ser. No. 63/652,454 filed on May 28, 2024, the entire disclosure of which is incorporated herein by reference.

### BACKGROUND OF THE INVENTION

The present disclosure relates to systems and methods for processing asphalt shingles. In particular, the present disclosure relates to systems and methods for recovering bitumen (also known as asphalt), granules, and limestone fillers from asphalt shingles.

Shingles are roofing materials which are used to cover and protect the rooftops of residential homes from moisture ingress and other environmental elements. Typically, shingles are flat, rectangular elements which are laid in an overlapping arrangement starting from the edge of the rooftop and ending at the pitch of the rooftop. Asphalt shingles are generally comprised of bitumen and other constituents, such as limestone, and are commonly selected for roofing projects due to their longevity and cost-effectiveness. The lifespan of asphalt shingles is typically between 20-30 years. Thus, over time, these shingles must be replaced with new shingles due to wear, typically requiring the used shingles to be torn off of the rooftop to which they were applied. The constituents of used asphalt shingles and, in particular, bitumen, are valuable if isolated and repurposed or reused. However, because the constituents of such shingles are not readily separable, they are often discarded as waste. As a result, fifteen million tons of used shingles are disposed of in landfills annually.

As recovering and recycling the key raw materials from used asphalt shingles serves to reduce greenhouse gas emissions, waste, and pollution, while also creating a sustainable circular economy for the asphalt shingle industry, efforts have been made to develop systems and methods for recovering such materials. For example, U.S. Pat. No. 11,591,524 discloses a method of separating and extracting raw materials from asphaltic limestone powder in which water, a polar solvent, is mixed with limonene, a non-polar hydrocarbon solvent, and spun in a centrifuge to separate asphalt from limestone, glass, and sand. This method thus produces a mixture of polar solvent (water), non-polar solvent (limonene), and fine solid emulsion which renders it difficult and expensive to separate and recover the asphalt as a product and generates a significant quantity of by-product waste stream. For another example, U.S. Pat. No. 11,492,455 discloses a method, process, and system for recycling an asphalt-based roofing material which uses high-pressure steam to mechanically extract asphalt. However, such technique likewise generates an emulsion mixture of polar solvent (water), non-polar asphalt, and fine solids which renders it difficult and expensive to separate and to recover the various constituents and may require a polar solvent to extract the bitumen and generate a significant quantity of by-product waste stream.

Accordingly, there remains a need in the art for novel systems and methods for recovering constituents, like bitumen, from asphalt shingles.

### SUMMARY OF THE INVENTION

The present disclosure relates to systems and methods for recovering bitumen (also known as asphalt), granules, and limestone fillers from asphalt shingles.

An exemplary system for recovering bitumen, granules, and limestone fillers from asphalt shingles (or system) includes: a mixer that is configured to receive and mix asphalt shingles (in whole or in part) and a solvent to produce a slurry; a filter configured to receive and process the slurry to generate a cake material and a filtrate; a first dryer configured to receive and heat the cake material; a centrifuge configured to receive and separate the filtrate into a first phase material and a second phase material; a second dryer configured to receive and heat the first phase material; and a distillation unit configured to receive and process the second phase material. When the system is in use, heating of the cake material by the first dryer isolates a first constituent of the asphalt shingles, heating of the first phase material by the second dryer isolates a second constituent of the asphalt shingles, and processing of the second phase material by the distillation unit isolates a third constituent of the asphalt shingles. In some embodiments, the first constituent of the asphalt shingles isolated by the system is granules (e.g., mineral granules), the second constituent of the asphalt shingles isolated by the system is limestone filler, and the third constituent of the asphalt shingles isolated by the system is bitumen.

In some embodiments, the system further includes one or more solvent recovery subsystems configured to recover solvent. In some embodiments, the one or more solvent recovery subsystems are configured to recover solvent from the first dryer, the distillation unit, the second dryer, or a component of the system that is in fluid communication with, and downstream of, the second dryer.

In some embodiments, the system includes: a first solvent recovery subsystem that is in fluid communication with the first dryer; a second solvent recovery subsystem that is in fluid communication with a baghouse that is in fluid communication with the second dryer and configured to isolate the second constituent from received exhaust; and a third solvent recovery subsystem that is in fluid communication with the distillation unit. In some embodiments, each solvent recovery subsystem of the system includes a condenser for condensing vapor to a liquid state, and a pump for pumping liquid received from the condenser. In some embodiments, the baghouse is in fluid communication with a cyclone separator of the system that, in turn, is in fluid communication with the second dryer.

In some embodiments, the filter and the centrifuge are in fluid communication with one another via a filter recovery subsystem that includes a condenser to condense the filtrate to a liquid state, and a pump to pump the filtrate in the liquid state to the centrifuge.

In some embodiments, the centrifuge comprises multiple centrifuges. In some embodiments the centrifuge includes a decanter centrifuge and a disc-stack centrifuge that is in fluid communication with the decanter centrifuge.

In some embodiments, the mixer is an acoustic mixer.

In some embodiments, the system further includes a solvent tank in fluid communication with the mixer, where the solvent tank contains recovered solvent from a solvent recovery subsystem of the system. In some embodiments, the recovered solvent is an aromatic solvent, a petroleum-based solvent, a terpene solvent, a biodiesel solvent including one or more mono-alkyl esters, or combinations thereof.

In some embodiments, the aromatic solvent is selected from the group consisting of: benzonitrile, phenol, toluene, benzoic acid, benzaldehyde, acetophenone, styrene, anisole, aniline, benzenesulfonic acid, o-xylene, mesitylene, and combinations thereof.

In some embodiments, the petroleum-based solvent is diesel fuel.

In some embodiments, the monoterpene solvent is selected from the group consisting of: citral; carvone; pulegone; citronellal; α-terpinene; β-terpinene; γ-terpinene; α-pinene; β-pinene; limonene; p-cymene; farnesene; sabinene; geraniol; β-citronellol; linayl acetate; 3-carene; 4-carene; 1,8-cineole; terpinene-4-ol; menthol, p-hydroquinone; myrtenal; carvacryl acetate; germacene; camphor; camphene; caryophyllene; γ-cadinene; nerol acetate; nerol; borneol; bornyl acetate; α-thujone; fenchone; estragole; verbenol; β-ociemene; geranial; geranyl acetate; camporene; chavicol; thujene; α-bisabolol; α-phellandrene; β-phellandrene; linalool; β-myrcene; carvacrol; terpinolene; eugenol; terpineol; menthone; anethole; nerolidol; cuminaldehyde; isopulegol; and combinations thereof.

In some embodiments, the biodiesel solvent includes one or more long-chain mono-alkyl esters.

In some embodiments, the recovered solvent is a solvent blend including multiple solvents. In some embodiments, the solvent blend includes a combination of two or more solvents selected from the aromatic solvent, the petroleum-based solvent, the terpene solvent, and the biodiesel solvent.

In some embodiments, the recovered solvent includes one or more mono-alkyl esters and one or more monoterpenes.

In some embodiments, the recovered solvent is non-polar.

In some embodiments, the recovered solvent includes one or more fatty acid amines.

Another exemplary system for recovering constituents of asphalt shingles (or system) includes: a mixer configured to receive and mix asphalt shingles and a solvent to produce a slurry; a centrifuge configured to receive and separate the slurry into a first phase material and a second phase material; a dryer configured to receive and heat the first phase material to recover a first constituent of the asphalt shingles; and a distillation unit configured to receive and process the second phase material to recover a second constituent of the asphalt shingles. In some embodiments, the first constituent is limestone filler, and the second constituent is bitumen.

An exemplary method for recovering bitumen, granules, and limestone fillers from asphalt shingles (in whole or in part) includes steps of: (a) mixing a solvent and asphalt shingles to produce a slurry; (b) processing the slurry to produce a cake material and a filtrate; (c) drying the cake material to isolate granules within the asphalt shingles; (d) centrifuging the filtrate to produce a first phase material including limestone filler and a second phase material including bitumen; (e) drying the first phase material to isolate the limestone filler; and (f) distilling the second phase material to isolate the bitumen.

In some implementations, the asphalt shingles mixed with the solvent are in granular form.

In some implementations, the solvent is an aromatic solvent, a petroleum-based solvent, a terpene solvent, a biodiesel solvent, or combinations thereof.

In some implementations, the aromatic solvent is selected from the group consisting of: benzonitrile, phenol, toluene, benzoic acid, benzaldehyde, acetophenone, styrene, anisole, aniline, benzenesulfonic acid, o-xylene, mesitylene, and combinations thereof.

In some implementations, the petroleum-based solvent is diesel fuel.

In some implementations, the monoterpene solvent is selected from the group consisting of: citral; carvone; pulegone; citronellal; α-terpinene; β-terpinene; γ-terpinene; α-pinene; β-pinene; limonene; p-cymene; farnesene; sabinene; geraniol; β-citronellol; linayl acetate; 3-carene; 4-carene; 1,8-cineole; terpinene-4-ol; menthol, p-hydroquinone; myrtenal; carvacryl acetate; germacene; camphor; camphene; caryophyllene; γ-cadinene; nerol acetate; nerol; borneol; bornyl acetate; α-thujone; fenchone; estragole; verbenol; β-ociemene; geranial; geranyl acetate; camporene; chavicol; thujene; α-bisabolol; α-phellandrene; β-phellandrene; linalool; β-myrcene; carvacrol; terpinolene; eugenol; terpineol; menthone; anethole; nerolidol; cuminaldehyde; isopulegol; and combinations thereof.

In some implementations, the biodiesel solvent includes one or more long-chain mono-alkyl esters.

In some implementations, the solvent is a blend of multiple solvents. In some implementations, the solvent blend includes two or more solvents selected from the aromatic solvent, the petroleum-based solvent, the terpene solvent, and the biodiesel solvent.

In some implementations, the solvent includes one or more mono-alkyl esters and one or more monoterpenes. In some implementations, the solvent is non-polar.

In some implementations, the solvent includes one or more fatty acid amines.

In some implementations, the method further includes a step of recovering at least one of solvent present in the cake material, solvent present in the first phase material, and solvent in the second phase material.

In some implementations, the method further includes a step of recirculating solvent recovered from the cake material, solvent recovered from the first phase material, and/or solvent recovered from the second phase material to a mixer from which the slurry was produced.

In some implementations, centrifuging the filtrate includes centrifuging the filtrate by a first centrifuge, and centrifuging, by a second centrifuge, liquid received from the first centrifuge.

### DESCRIPTION OF THE DRAWINGS

FIG. 1A is a schematic view of a first portion of an exemplary system for recovering bitumen, granules, and limestone fillers from used asphalt shingles made in accordance with the present disclosure;

FIG. 1B is a schematic view of a second portion of the exemplary system for recovering bitumen, granules, and limestone fillers from used asphalt shingles of FIG. 1A;

FIG. 2 is flow diagram of an exemplary method for recovering bitumen, granules, and limestone fillers from used asphalt shingles in accordance with the present disclosure;

FIG. 3. is an image of asphalt shingle granules that can be supplied to the exemplary system for recovering bitumen, granules, and limestone fillers from used asphalt shingles of FIGS. 1A and 1B, and utilized in the exemplary method for recovering bitumen, granules, and limestone filler; and

FIG. 4 is a schematic diagram of a control subsystem that can be utilized in the exemplary system for recovering bitumen, granules, and limestone fillers from used asphalt shingles of FIGS. 1A and 1B.

### DETAILED DESCRIPTION OF THE INVENTION

The present disclosure includes a system and a method for recovering bitumen (also known as asphalt), granules, and limestone filler from asphalt shingles.

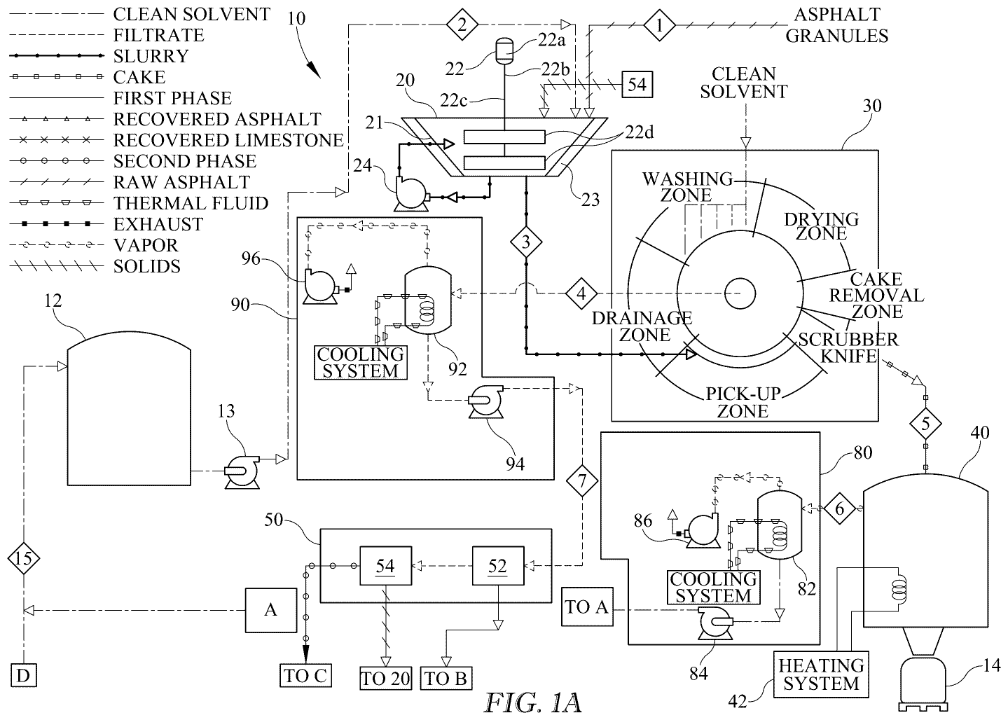

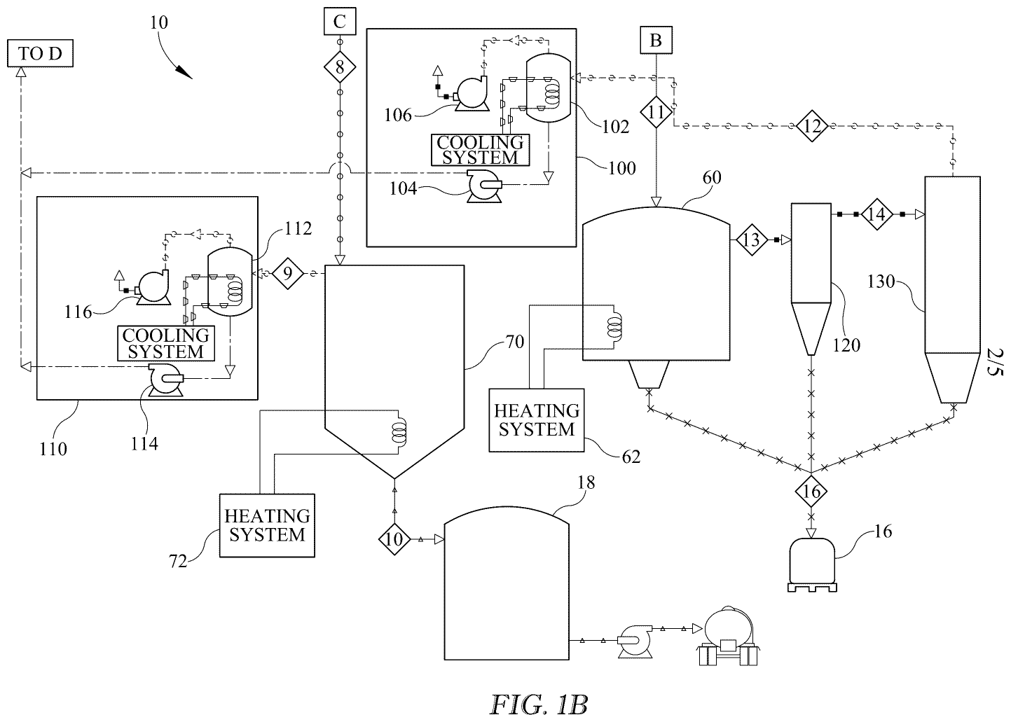

Referring first to FIGS. 1A and 1B, an exemplary system for recovering bitumen, granules, and limestone filler from asphalt shingles (or system) 10 made in accordance with the present disclosure includes: a mixer 20; a filter 30; a first dryer 40; a centrifuge 50; a second dryer 60; and a distillation unit 70. The mixer 20 is configured to receive and mix asphalt shingles (in whole or in part) to produce a solvent-asphalt shingle slurry. The filter 30 is configured to receive and process the solvent-asphalt shingle slurry to generate a cake material and a filtrate. The first dryer 40 is configured receive and heat the cake material to isolate a first constituent of the asphalt shingles. The centrifuge 50 is configured to receive and separate the filtrate into a first phase material and a second phase material. The second dryer 60 is configured to receive and heat the first phase material to isolate a second constituent of the asphalt shingles. The distillation unit 70 is configured to receive and process the second phase material to isolate a third constituent of the asphalt shingles. The respective constituents isolated by the system 10 can be reused and/or repurposed. In some embodiments, the system 10 further includes one or more solvent recovery subsystems 80, 100, 110 to recover and recirculate clean solvent.

Referring now specifically to FIG. 1A, in this exemplary embodiment, the mixer 20 is a motor-driven mixer that includes: a receptacle 21 that defines, and thus can be characterized as including, an interior volume in which asphalt shingles, which may be in the form of asphalt granules, and solvent can be deposited; and a mixing element 22 (which can also be characterized as an agitator) that is positioned and can be selectively activated to mix asphalt shingles and solvent deposited in the interior volume of the receptacle 21 to produce the solvent-asphalt shingle slurry. The solubility of asphalt increases in elevated temperatures. Accordingly, to facilitate mixing and formation of the solvent-asphalt shingle slurry, in this exemplary embodiment, the mixer 20 is adapted to be selectively heated to heat the materials deposited in the interior volume of the receptacle 21 to a predetermined temperature or within a predetermined temperature range. As such, in this exemplary embodiment, the mixer 20 further includes a heating element 23 that can be selectively activated to heat the contents of the receptacle 21. In various embodiments and implementations, the predetermined temperature or predetermined temperature range can be adjusted to accommodate the specific composition and/or characteristics of the asphalt shingles and/or solvent utilized.

Referring still to FIG. 1A, in some embodiments and implementations, the solvent is, at least in part, comprised of a biodiesel solvent that includes one or more mono-alkyl esters (also known as fatty acid esters or fatty esters). For instance, in some embodiments and implementations, the solvent is comprised, at least in part, of d-limonene and diesel fuel. It has been discovered that a solvent consisting of d-limonene and diesel fuel reduces asphalt recovery loss when provided in the mixer 20 in a 1:1 weight percentage (wt %) ratio with asphalt shingles, and, as such, is particularly effective with respect to recovering asphalt from asphalt shingles. In this regard, it has been found that lower solvent-to-asphalt shingle ratios increase asphalt recovery loss. Of course, the optimal ratio of solvent-to-asphalt shingles may vary depending on the composition and/or characteristics of the particular solvent utilized, mixing power, delve time, temperature, and/or the asphalt shingles utilized.

Referring still to FIG. 1A, it has also been discovered that heating the solvent-asphalt shingle slurry resulting from the mixture of such biodiesel solvent and the asphalt shingles to a temperature ranging from about 110° F. to about 160° F. promotes dissolution of asphalt shingles in a manner that permits the solvent-asphalt shingle slurry to be readily processed by the filter 30, while also limiting mixing time, mixing power requirements (and thus energy consumption), and vapor emissions. Accordingly, in some embodiments, the heating element 23 of the mixer 20 is adapted to heat the solvent within the interior volume of the receptacle 21 of the mixer 20 to a temperature ranging from about 110° F. to about 160° F. In some embodiments and implementations, the solvent-asphalt shingle slurry resulting from the mixture of the above-noted biodiesel solvent and asphalt shingles is heated to about 150° F. Again though, the optimal temperature or range of temperatures to which the materials deposited in the mixer 20 is preferably heated may vary depending on the composition and/or characteristics of the solvent and/or asphalt shingles utilized. It is therefore appreciated that the heating element 23 utilized can be selected or adapted to accommodate the specific heating requirements of the solvent and/or asphalt shingles utilized.

It is appreciated that the term “about,” as used herein when referring to a value or to an amount of mass, weight, time, volume, size, temperature, concentration, or percentage is meant to encompass variations of in some embodiments ±20%, in some embodiments ±10%, in some embodiments ±5%, in some embodiments ±1%, in some embodiments ±0.5%, in some embodiments ±0.1%, in some embodiments ±0.01%, and in some embodiments ±0.001% from the specified amount, as such variations are appropriate.

It is further appreciated that, as used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that where a range of units is disclosed, such range is inclusive of the starting and end units. For example if a range of “10 to 15” or “between 10 to 15” is disclosed, then 10 and 15 are considered part of such range, unless stated otherwise. It is also understood that each unit between two particular units are also disclosed. For example, if 10 and 15 are disclosed, then 11, 12, 13, and 14 are also disclosed.

Referring now again to FIG. 1A, in this exemplary embodiment, the heating element 23 is in the form of a heating jacket that extends around the interior volume defined by, and can be selectively activated to heat, the receptacle 21 of the mixer 20. Specifically, in this exemplary embodiment, the receptacle 21 is a jacketed receptacle, such that the heating element 23 is integrated with the receptacle 21. Suitable mixing tanks employing such construction and which can be utilized in the mixer 20 include, by way of non-limiting example, the 1500-gallon Jacketed Mix Tank (304 L S/S, Vertical, 96″ diameter×43″ straight side, 150 psi at −20 to 250° F.), manufactured by Walker Stainless Equipment Co., Inc. of New Lisbon, Wisconsin. It is appreciated, however, that, in alternative embodiments, other types of heating elements can be utilized. In this regard, alternative embodiments in which a heating coil serves as the heating element 23, as well as embodiments in which an external heat exchanger serves as the heating element 23 are also contemplated herein.

Referring still to FIG. 1A, without wishing to be bound by any particular theory, it has been discovered that a vertical mixing arrangement in which a motor-driven mixing element in the form of a bladed agitator is vertically oriented in the interior volume of a vertical tank is particularly well-suited in applications where larger volumes of solvent-asphalt shingle slurry are to be produced, and in which larger volumes of liquid solvent are utilized. Such mixing arrangements have also been found to be well-suited for achieving rotational speeds for producing a solvent-asphalt shingle slurry that can be readily processed during certain downstream processing operations further described below. Thus, in this exemplary embodiment, the receptacle 21 is in the form of a vertical tank, and the mixing element 22 is in the form of a motor-driven bladed agitator that is vertically oriented in the interior volume defined by the receptacle 21. The mixing element 22 includes a motor 22a and a mixing member 22b with a shaft 22c that is driven by motor 22a, along with one or more impellers 22d that extend from the shaft 22c. The above-identified 1500-gallon Jacketed Mix Tank (304 L S/S, Vertical, 96″ diameter×43″ straight side, 150 psi at −20 to 250° F.) manufactured by Walker Stainless Equipment Co., Inc. of New Lisbon, Wisconsin is an example of such a vertical tank construction.

In this exemplary embodiment, the mixing element 22 includes two impellers 22d for mixing the asphalt shingles and the solvent. The use of a dual-impeller arrangement provides for uniform mixing in tall, vertical tanks. Although the mixing element 22 in this exemplary embodiment is of a dual-impeller construction, it is appreciated that alternative embodiments in which the mixing element 22 includes only a single impeller, as well as alternative embodiments in which the mixing element 22 includes more than two impellers, are also contemplated herein. The dimensions of the respective impellers 22d of the mixing element 22 can be adjusted to accommodate different volumes and/or types of asphalt shingles and solvent mixtures.

Although the mixer 20 is referred to above as employing a vertical mixing arrangement, it is appreciated that the mixer 20 is not limited to such arrangement. Rather, the mixer 20 can, in alternative embodiments, have alternative mixing arrangements and still produce a solvent-asphalt shingle mixture from which useful constituents of the asphalt shingles can be recovered through subsequent processing operations consistent with that disclosed below. For instance, in some alternative embodiments, instead of the mixing element 22 having a bladed agitator, the mixing element 22 can include a helical mixing member. Furthermore, an alternative embodiment in which the receptacle is a horizontal tank and the mixing element is a ribbon blender horizontally oriented within the interior volume defined by the horizontal tank have also be found to produce solvent-asphalt shingle mixtures from which the constituents of the asphalt shingles can be recovered.

In some alternative embodiments, instead of the mixing element 22 being configured to mechanically mix the solvent and asphalt shingles, an acoustic mixer that generates soundwaves to mix the solvent and the asphalt shingles can be utilized. In some embodiments, the acoustic mixer is configured to generate low-frequency sound waves (e.g., 60 Hz) to cause solid particles to move back and forth during mixing. Suitable acoustic mixers that can be utilized as the mixer 20 include those manufactured by Resodyn Acoustic Mixers of Butte, Montana. For instance, in some embodiments, the Continuous Acoustic Mixing (CAM) RAM 55 system manufactured by Resodyn Acoustic Mixers may be utilized. The use of soundwaves to facilitate the mixing of the solvent and the asphalt shingles instead of mechanical movement may serve to reduce wear and/or maintenance of the mixer 20 while still providing good mixing efficiency. Additionally, the use of an acoustic mixer for mixing the solvent and asphalt shingles may serve to reduce equipment size, and thus the overall footprint of the system 10, reduce cost, and limit solid settling and compaction issues caused thereby.

Referring still to FIG. 1A, to further facilitate mixing and formation of the solvent-asphalt shingle slurry, in this exemplary embodiment, the mixer 20 further includes a pump 24 that recirculates the solvent-asphalt shingle slurry in the receptacle 21. Accordingly, in this exemplary embodiment, the pump 24 is in fluid communication with an outlet of the mixer 20 from which solvent-asphalt shingle slurry flows to the pump 24 and an inlet of the mixer into which solvent-asphalt shingle slurry is directed from the pump 24 to recirculate the solvent-asphalt shingle slurry. Pumps suitable for recirculating the solvent-asphalt shingle slurry are known in the art and readily available. Of course, embodiments in which the heating element 23 and/or pump 24 is omitted from the system 10 are also contemplated. Accordingly, in some alternative embodiments, mixing of the solvent and the asphalt shingles is achieved by operation of the mixing element 22 alone.

Referring still to FIG. 1A, the filter 30 is in fluid communication with the mixer 20, such that the solvent-asphalt shingle slurry generated and output by the mixer 20 is subsequently introduced to the filter 30, as indicated by stream 3 in FIG. 1A. In this exemplary embodiment, the filter 30 is a continuous filtration device. Specifically, in this exemplary embodiment, the filter 30 is a rotary drum vacuum filter that is configured to process the mixed materials received from the mixer 20 and discharge a cake material and a filtrate. In this exemplary embodiment, the filter 30 is a rotary vacuum-drum filter with a membrane that is sized to allow the fine particulates, such as limestone filler, to pass through the filter media with the filtrate while retaining larger granules. Suitable rotary drum vacuum filters which may be utilized as the filter 30 include, by way of non-limiting example, the Rotary Drum Vacuum Filter (RDVF) manufactured by Komline-FluidQuip of Springfield, Ohio and the YU vacuum drum filter manufactured by ANDRITZ AG of Graz, Austria. In alternative embodiments, instead of a rotary drum vacuum filter, the filter 30 can be in the form of a rotary pressure drum filter or a rotary belt filter and still discharge the cake material and the filtrate in the desired manner. Alternative embodiments in which the filter 30 is a pusher centrifuge instead of a rotary vacuum-drum filter are also contemplated herein. In alternative embodiments, a rotary pressure filter, such as the Krauss-Maffei pressure drum filter TDF or the PYU pressure drum filter, each manufactured by ANDRITZ AG of Graz, Austria, can be utilized.

Referring still to FIG. 1A, the filter 30 is in fluid communication with the first dryer 40, such that the cake material discharged from the filter 30 is received by the first dryer 40, as indicated by stream 5 in FIG. 1A. To facilitate transport of the cake material discharged by the filter to the first dryer 40, in some embodiments, the first dryer 40 is provided below the cake removal zone of the filter 30. In alternative embodiments, a chain conveyor or other suitable conveying means can be employed to facilitate transport of the cake material to the first dryer 40. The first dryer 40 includes a heating component 42 which can be selectively activated to heat the cake material received by the first dryer 40, the importance of which is further discussed below. In this exemplary embodiment, the first dryer 40 is a continuous rotary vacuum dryer. Suitable continuous rotary vacuum tray driers which may be utilized as the first dryer. Various alternative embodiments are also contemplated in which the first dryer 40 is alternatively a drum dryer, a fluidized bed dryer, or a spray dryer.

Referring still to FIG. 1A, in this exemplary embodiment, the system 10 further includes a first solvent recovery subsystem 80 that is in fluid communication with the first dryer 40, such that vapor generated during drying of the cake material is directed to the first solvent recovery subsystem 80 for subsequent processing, as indicated by stream 6 in FIG. 1A. Specifically, in this exemplary embodiment, the first solvent recovery subsystem 80 is configured to condense the received vapor into a liquid state which can then be reused within the system 10, as further discussed below. To this end, the first solvent recovery subsystem 80 includes: a condenser 82; a first pump 84; and a second pump 86. Vapor from the first dryer 40 is initially received into the first solvent recovery subsystem 80 by the condenser 82, which condenses the received vapor into a liquid state. The first pump 84 is in fluid communication with the condenser 82 and a tank 12, such that the first pump 84 can be activated to pump liquid received from the condenser 82 to the tank 12 for temporary storage before being circulated back to the mixer 20 for reuse in the system 10, as indicated by stream 15 in FIG. 1A. The second pump 86 is in fluid communication with the condenser 82, such that the second pump 86 can be activated to exhaust excess vapor in the first solvent recovery subsystem 80 (i.e., vapor which is not condensed by the condenser 82). Pumps that can be utilized as the first pump 84 and the second pump 86 of the first solvent recovery subsystem 80 are known within the art and readily available. Condensers that can be utilized as the condenser 82 of the first solvent recovery subsystem 80 are likewise known within the art and readily available.

Referring still to FIG. 1A, in this exemplary embodiment, the system 10 further includes an intermediate filter recovery subsystem 90, which places the filter 30 in fluid communication with the centrifuge 50, as indicated by streams 4 and 7 in FIG. 1A. Like the first solvent recovery subsystem 80, the filter recovery subsystem 90 is also configured to condense received vapor into a liquid state for subsequent use in system operations. In this regard, the filter recovery subsystem 90 also includes: a condenser 92; a first pump 94; and a second pump 96. The condenser 92 is in fluid communication with the filter 30, such that vapor from the filter 30 is initially received into the filter recovery subsystem 90 by the condenser 92, which subsequently condenses the received vapor into a liquid state. The first pump 94 is in fluid communication with the condenser 92 and the centrifuge 50, such that the first pump 94 can be activated to pump liquid received from the condenser 92 to the centrifuge 50 for further processing. The second pump 96 is in fluid communication with the condenser 92, such that the second pump 96 can be activated to exhaust excess vapor in the filter recovery subsystem 90 (i.e., vapor which is not condensed by the condenser 92). Pumps that can be utilized as the first pump 94 and the second pump 96 of the filter recovery subsystem 90 are known within the art and readily available. Condensers that can be utilized as the condenser 92 of the filter recovery subsystem 90 are likewise known within the art and readily available.

Referring still to FIG. 1A, the liquid received by the centrifuge 50 from the filter recovery subsystem 90 will typically include a mixture of both solids and liquids. The centrifuge 50 is configured to promote separation of the received mixture into a first phase material and a second phase material that are subsequently processed by the system 10. As shown, in this exemplary embodiment, the centrifuge 50 is actually comprised of multiple centrifuges 52, 54 that are in fluid communication with each other and are configured to separate solids from liquid in the received mixture. Specifically, in this exemplary embodiment, the centrifuge 50 is comprised of two centrifuges: a decanter centrifuge 52 that is in fluid communication with, and receives the liquid from, the filter recovery subsystem 90; and a disc-stack centrifuge 54 that is in fluid communication with, and receives liquid from, the decanter centrifuge 52. Accordingly, in this exemplary embodiment, the decanter centrifuge 52 and the disc-stack centrifuge 54 are arranged in a series. The decanting centrifuge 52 and the disc-stack centrifuge 54, in this exemplary embodiment, thus each include an inlet for receiving a flow of liquid, a first outlet from which separated solids are discharged, and a second outlet from which liquid is discharged.

Referring now to FIGS. 1A and 1B, the decanter centrifuge 52 utilizes centrifugal force to separate solids from liquid in the received mixture and then separately discharges the separated liquids and solids to different downstream components of the system 10. Specifically, in this exemplary embodiment, the separated liquid from the decanter centrifuge 52 is directed to the disc-stack centrifuge 54 for further processing, and the separated solids from the decanter centrifuge 52 are directed to a second dryer 60 for further processing, as further discussed below. The disc-stack centrifuge 54 utilizes centrifugal force and a series of stacked discs (that may be conically shaped) to separate solids from liquid in the liquid received from the decanter centrifuge 52. The liquid discharged from the decanter centrifuge 52 may include finer solids that the decanter centrifuge 52 was unable to separate sufficiently to meet certain quality requirements, which the disc-stack centrifuge 54 is able to separate due to the generally higher centrifugal force applied during its operation and increased separation area resulting from the series of stacked plates.

Referring still to FIGS. 1A and 1B, as with the decanter centrifuge 52, solids separated by the disc-stack centrifuge 54 are discharged from the disc-stack centrifuge 54 and directed to the mixer 20 for reprocessing. The liquid separated by the disc-stack centrifuge, which, following discharge from the disc-stack centrifuge 54 has been twice processed to remove solids therefrom, is directed to the distillation unit 70 for further processing. The use of multiple centrifuges in series thus helps to facilitate optimal solid-liquid separation. One suitable centrifuge that can serve as the decenter centrifuge 52 is, by way of non-limiting example, the CenTex 1865 centrifuge manufactured by CenTex Centrifuge, LLC of Conroe, Texas. One suitable centrifuge that can serve as the disc-stack centrifuge 54 is, by way of non-limiting example, the Alfa Laval MOPX 207 centrifuge manufactured by Alfa Laval of Greenwood, Indiana.

Referring still to FIGS. 1A and 1B, in this exemplary embodiment, the stream discharged by the centrifuge 50 to the second dryer 60 defines the first phase material separated by the centrifuge 50, and the stream discharged by the centrifuge 50 to the distillation unit 70 defines the second phase material separated by the centrifuge 50. While the stream discharged by the centrifuge 50 to the second dryer 60 is primarily referred to above as being solids separated by the centrifuge 50, it is appreciated that some amount of liquid from the mixture received by the centrifuge 50 may be present in such stream. Likewise, while the stream discharged by the centrifuge 50 to the distillation unit 70 is primarily referred to above as being liquid separated by the centrifuge 50, it is appreciated that some amount of solids from the mixture received by the centrifuge 50 may be present in such stream.

Although the two centrifuges 52, 54 of the centrifuge 50 are referred to above as being a decanter centrifuge and a disc-stack centrifuge, alternative embodiments in which one or both centrifuges of the centrifuge 50 are substituted for another type of centrifuge are also contemplated herein. For instance, in some alternative embodiments, the decanter centrifuge is replaced by a sedimentation centrifuge, a disc-stack centrifuge, or a filtration centrifuge, and/or the disc-stack centrifuge is replaced by a sedimentation centrifuge, a decanter centrifuge, or a filtration centrifuge. Accordingly, improved solid-liquid separation of the mixture received from the intermediate filter recovery subsystem 90 may be realized through the use of a first centrifuge and a second centrifuge fluidly connected in series, where the first centrifuge and the second centrifuge can be selected from various types of centrifuges.

Furthermore, the centrifuge 50 is not necessarily limited to a construction in which two centrifuges are fluidly connected in series. Rather, alternative embodiments, in which the two centrifuges are fluidly connected in parallel, such that two separate streams of mixture from the intermediate filter recovery subsystem 90 are independently received and processed by a first centrifuge and a second centrifuge of the centrifuge 50, are also contemplated herein. Furthermore, while the use of multiple centrifuges in the centrifuge 50 is generally preferred to provide multiple phases of solid-liquid separation, alternative embodiments in which the centrifuge 50 comprises only a single centrifuge are also contemplated herein. For instance, in some alternative embodiments, the centrifuge 50 can consist of a single decanter centrifuge, sedimentation centrifuge, disc-stack centrifuge, or filtration centrifuge.

Referring now specifically to FIG. 1B, the second dryer 60 is positioned and configured to receive the first phase material discharged from the centrifuge 50 and includes a heating component 62 that can be selectively activated to heat the first phase of material, the importance of which is further discussed below. In this exemplary embodiment, the second dryer 60 is a continuous fluidized bed dryer. One suitable fluidized bed dryer that can be utilized as the second dryer 60 is, by way of non-limiting example, the Carrier Vibrating Fluid Bed Dryer Model QAD-48080S, manufactured by Carrier Vibrating Equipment of Louisville, Kentucky. Alternative dryer types can, however, be utilized as the second dryer 60 without departing from the spirit and scope of the present disclosure. For instance, in various alternative embodiments, the second dryer 60 can be a tray dryer, a vacuum dryer, a pan dryer, a bin dryer, a vibrating fluidized bed dryer, an agitated vacuum dryer, a flash dryer, a drum dryer, a vacuum drum dryer, a vacuum tray dryer, a spray dryer, or combinations thereof. Such dryers are known within the art and readily available.

Referring still to FIG. 1B, in this exemplary embodiment, the system 10 further includes a cyclone separator 120 and a baghouse 130. The cyclone separator 120 is downstream of, and in fluid communication with, the second dryer 60, as indicated by stream 13 in FIG. 1B, and is configured to recover constituents, such as limestone filler, from exhaust received from the second dryer 60. The baghouse 130 is downstream of, and in fluid communication with, the cyclone separator 120, as indicated by stream 14 in FIG. 1B, and is configured to recover constituents, such as limestone filler, from exhaust received from the cyclone separator 120. The baghouse 130 can thus be characterized as being downstream of, and in indirect fluid communication with the second dryer 60 in this exemplary embodiment.

Referring now again to FIGS. 1A and 1B, in this exemplary embodiment, the system 10 further includes a second solvent recovery subsystem 100 that is in fluid communication with a baghouse 130, as reflected by stream 12 in FIG. 1B. Specifically, the second solvent recovery subsystem 100 is in fluid communication with the baghouse 130, such that vapor from the baghouse 130 is directed to the second solvent recovery subsystem 100 for subsequent processing. Specifically, in this exemplary embodiment, the second solvent recovery subsystem 100 is configured to condense the received vapor into a liquid state which can then be reused within the system 10, as further discussed below. To this end, the second solvent recovery subsystem 100 also includes: a condenser 102; a first pump 104; and a second pump 106. Vapor from the baghouse 130 is initially received into the second solvent recovery subsystem 100 by the condenser 102, which condenses the received vapor into a liquid state. The first pump 104 is in fluid communication with the condenser 102 and the tank 12, such that the first pump 104 can be activated to pump liquid received from the condenser 102 to a tank 12 for temporary storage before being circulated back to the mixer 20. The second pump 106 is in fluid communication with the condenser 102, such that the second pump 106 can be activated to exhaust excess vapor in the second solvent recovery subsystem 100 (i.e., vapor which is not condensed by the condenser 102). Pumps that can be utilized as the first pump 104 and the second pump 106 of the second solvent recovery subsystem 100 are known within the art and readily available. Condensers that can be utilized as the condenser 102 of the second solvent recovery subsystem 100 are likewise known within the art and readily available. Alternative embodiments in which the second solvent recovery subsystem 100 is in fluid communication with, and recovers solvent from, the cyclone separator 120 or the baghouse 130 of the system 10 are also contemplated herein.

Referring still to FIGS. 1A and 1B, the distillation unit 70 is in fluid communication with the centrifuge 50, as indicated by stream 8 in FIG. 1B, and configured to isolate solid constituents, such as asphalt, present in the second phase material discharged from the centrifuge 50. In this exemplary embodiment, the distillation unit 70 includes a heating component 72 that can be selectively activated to heat the second phase of material received from the centrifuge 50. One suitable distillation unit which may be utilized is the CRS two-gallon per minute distillation system manufactured by CRS-SPV Inc. d/b/a CRS Reprocessing Services of Louisville, Kentucky. In some embodiments, the distillation unit 70 comprises a classical distillation column, a batch distiller, a falling film evaporator, a thin film evaporator, a wipe film evaporator, or a combination thereof to promote recovery of the solid constituents. In some embodiments, the distillation unit 70 includes an evaporator that can be operated in multiple modes.

Referring now specifically to FIG. 1B, in some embodiments, the distillation unit 70 is a Photowatt Evaporator batch still, No. 0527-E1 in which primary and secondary shell-tube heat exchangers, installed in series, are used to condense solvent vapor, and an immersion heater is used to heat the thermal fluid that supplies the batch still. In use, the second phase material is provided to the batch still where the solvent is distilled under vacuum. Additional second phase material is provided to the batch still as the solvent is removed until the batch still is primarily full of concentrated asphalt. A hard vacuum can then be pulled to drive off remaining solvent to achieve a Cleveland Open-Cup (COC) flash point of ≥600° F.

Referring still to FIG. 1B, in some embodiments and implementations, the batch still can include a batch still circulation loop for recirculating the second phase material in the batch still. It has been discovered that a circulation loop arrangement in which the circulation pump intake and return ports are oriented at 90° and along the same plane can curtail force mixing by the batch still. To address this issue, in some embodiments, the batch still may thus include a circulation loop in which the return line (i.e., a conduit for redirecting the second phase material back to the batch still) is directed to a vapor head space of the batch still. In some embodiments, the second phase material directed to the batch still from the centrifuge 50 may be preheated and directed to a vapor head of the batch still to eliminate plugging and pump cavitation in the circulation loop. It has been discovered that heat transfer by the heating component 72 of the distillation unit 70 can be limited as a result of the liquid level in the batch still falling below the heating component 72 when an internal heating coil is utilized for the heating component 72. Accordingly, in some embodiments, an external heat exchanger may be implemented in the circulation loop to further facilitate heat exchange.

Although the distillation unit 70 is primarily referred to herein and illustrated in the drawings as comprising a single distillation unit, alternative embodiments in which the distillation unit 70 comprises multiple distillation units are also contemplated herein.

Referring now to FIGS. 1A and 1B, in this exemplary embodiment, the system 10 further includes a third solvent recovery subsystem 110 that is in fluid communication with the distillation unit 70, such that vapor generated during processing of the second phase material received from the centrifuge 50 by the distillation unit 70 is directed to the third solvent recovery subsystem 110 for subsequent processing. Specifically, in this exemplary embodiment, the third solvent recovery subsystem 110 is configured to condense the received vapor into a liquid state which can then be reused within the system 10, as further discussed below. To this end, the third solvent recovery subsystem 110 includes: a condenser 112; a first pump 114; and a second pump 116. Vapor from the distillation unit 70 is initially received into the third solvent recovery subsystem 110 by the condenser 112, which condenses the received vapor into a liquid state. The first pump 114 is in fluid communication with the condenser 112 and the tank 12, such that the first pump 114 can be activated to pump liquid received from the condenser 112 to a tank 12 for temporary storage before being circulated back to the mixer 20. The second pump 116 is in fluid communication with the condenser 112, such that the second pump 116 can be activated to exhaust excess vapor in the condenser 112 (i.e., vapor which is not condensed by the condenser 112). Pumps that can be utilized as the first pump 114 and the second pump 116 of the first solvent recovery subsystem 110 are known within the art and readily available. Condensers that can be utilized as the condenser 112 of the first solvent recovery subsystem 110 are likewise known within the art and readily available.

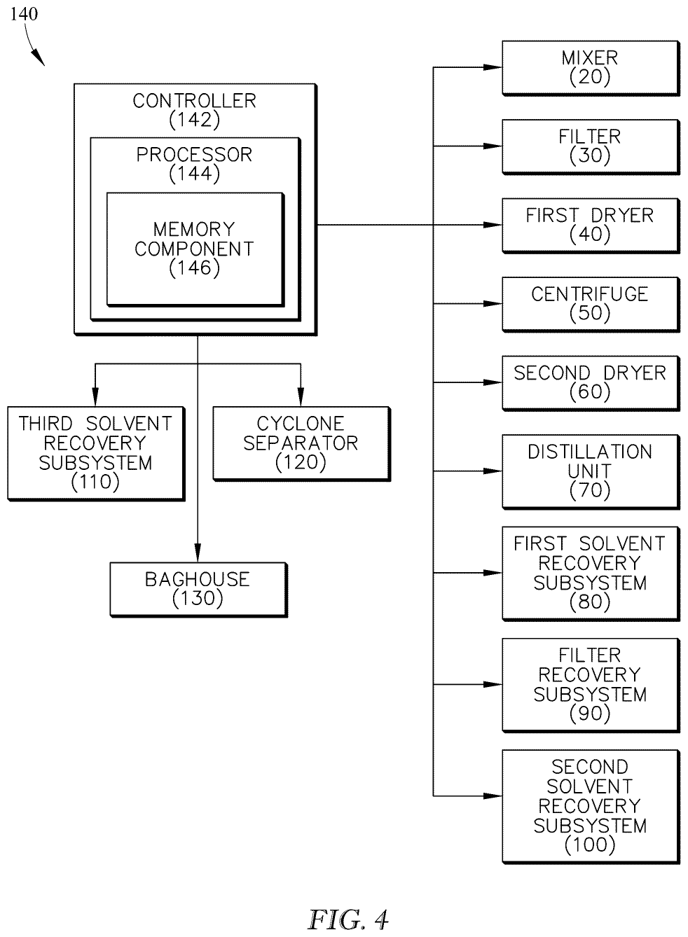

Referring now to FIG. 4, the system 10 can further include a control subsystem 140 that is configured to control and automate certain operations of the system 10. In various embodiments, the system 10 can include a control subsystem 140 that is operably connected to, and configured to regulate certain operations of, the mixer 20, the filter 30, the first dryer 40, the centrifuge 50, the second dryer 60, the distillation unit 70, the first solvent recovery subsystem 80, the filter recovery subsystem 90, the second solvent recovery subsystem 100, the third solvent recovery subsystem 110, the cyclone separator 120, and/or the baghouse 130. Accordingly, in some embodiments of the system 10 and implementations of the method disclosed herein, certain aspects of the system operations or method steps may be automated. As shown, the control subsystem 140 includes a controller 142, which includes a processor 144 for executing instructions (routines) stored in a memory component 146 or other computer-readable medium to carry out the operations of the controller 142 described herein.

Referring still to FIG. 4, in this exemplary embodiment, the control subsystem 140 of the system 10 is operably connected to the mixer 20, such that the controller 142 can selectively communicate instructions (signals) to: (i) the motor 22a of the mixing element 22 to selectively activate, deactivate, and/or increase or decrease the rotation speed of the mixing element 22; (ii) selectively communicate instructions to the selectively activate, deactivate, and/or regulate the heat produced by the heating element 23; and (iii) selectively communicate instructions to selectively activate the pump 24 of the mixer 20.

Referring still to FIG. 4, in this exemplary embodiment, the control subsystem 140 of the system 10 is also operably connected to the filter 30, such that the controller 142 can selectively communicate instructions (signals) to selectively activate and deactivate the filter 30.

Referring still to FIG. 4, in this exemplary embodiment, the control subsystem 140 of the system 10 is also operably connected to the first dryer 40, the second dryer 60, and the distillation unit 70, such that the controller 142 can selectively communicate instructions to selectively activate, deactivate, and/or regulate the heat produced by the heating components 42, 62, 72 of the first dryer 40, the second dryer 60, and/or the distillation unit 70.

Referring still to FIG. 4, in this exemplary embodiment, the control subsystem 140 of the system 10 is also operably connected to the centrifuge 50, such that the controller 142 can selectively communicate instructions to selectively activate, deactivate, and/or regulate the rotational speed of the decanter centrifuge 52 and/or the disc-stack centrifuge 54.

Referring still to FIG. 4, in this exemplary embodiment, the control subsystem 140 of the system 10 is also operably connected to the first solvent recovery subsystem 80, the filter recovery subsystem 90, the second solvent recovery subsystem 100, and the third solvent recover subsystem 110, such that the controller 142 can selectively communicate instructions to selectively activate and deactivate the condenser 82, 92, 102, 112 and/or pumps 84, 86, 94, 96, 104, 106, 114, 116 thereof.

Referring still to FIG. 4, in this exemplary embodiment, the control subsystem 140 of the system 10 is also operably connected to the baghouse 130, such that the controller 142 can selectively communicate instructions to selectively activate, deactivate, and/or regulate the speed of a fan or blower (not shown) of the baghouse 130.

Referring still to FIG. 4, in this exemplary embodiment, the control subsystem 140 of the system 10 is also operably connected to the cyclone separator 120, such that the controller 142 can selectively communicate instructions to activate or deactivate the cyclone separator 120.

Referring now to FIGS. 1A, 1B, 2, and 3, an exemplary method for recovering bitumen, granules, and limestone fillers from used asphalt shingles (in whole or in part) commences in step 202 with the mixer 20 receiving and subsequently mixing clean solvent and asphalt shingles to form a solvent-asphalt shingle slurry, which, is reflected by streams 1, 2, and 3 in FIG. 1A. To facilitate mixing of the solvent and the asphalt shingles, in this exemplary implementation, the mixing element 22 is activated to mix the solvent and the asphalt shingles, the heating element 23 is activated to heat the contents of the receptacle 21 to a predetermined temperature, and the pump 24 is activated to pump recirculate solvent-asphalt shingle slurry in the receptacle 21. In some embodiments and implementations, the solvent and the asphalt shingles are deposited in the mixer 20 in an equal weight ratio. Asphalt shingles fed to the mixer 20 can include fiberglass or cellulose mat, water-resistant bitumen binder, limestone filler, mineral granules, and release film. Depending on the size and density, fibers from the fiberglass or cellulose mat and release film, can be recovered and exit the system 10 via operation of the first dryer 40, the cyclone separator 120, or the baghouse 130.

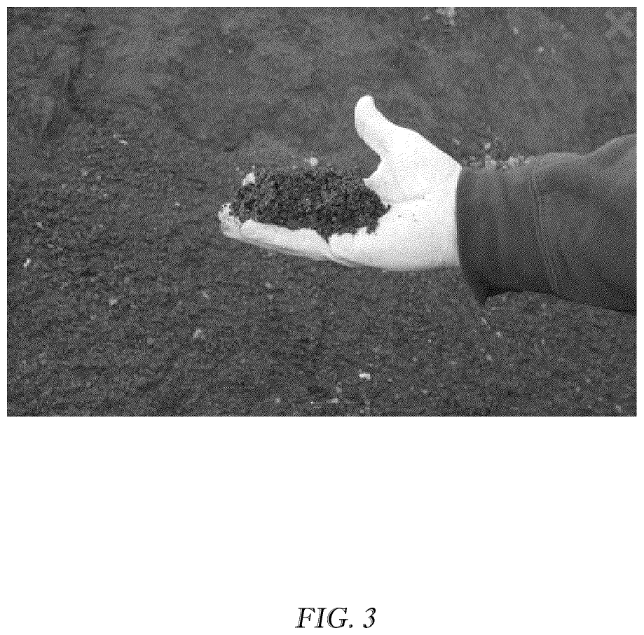

As shown in FIG. 1A, in this exemplary implementation, the asphalt shingles fed to the mixer 20 are in the form of asphalt granules. Accordingly, in this exemplary implementation, the asphalt shingles are mechanically pre-processed (i.e., broken down into smaller pieces) prior to introduction to the mixer 20, as best shown in FIG. 3. Techniques for processing shingles into granular form are known in the art and can be employed to produce asphalt granules suitable for use in the system 10. In some embodiments and implementations, the system 10 further includes suitable machinery for converting asphalt shingles into granular form, and the method further includes an asphalt-shingle pre-processing step. In some implementations, the asphalt granules introduced into the mixer 20 can range from about 0.1 millimeters to about 10.0 mm in diameter.

Although it is anticipated that the asphalt shingles fed to the mixer 20 will typically correspond to used asphalt shingles, such as those torn off a building prior to reroofing, it should be appreciated that the asphalt shingles introduced into the mixer 20 may be alternatively sourced and/or a mixture of used and unused asphalt shingles without departing from the spirit and scope of the present disclosure.

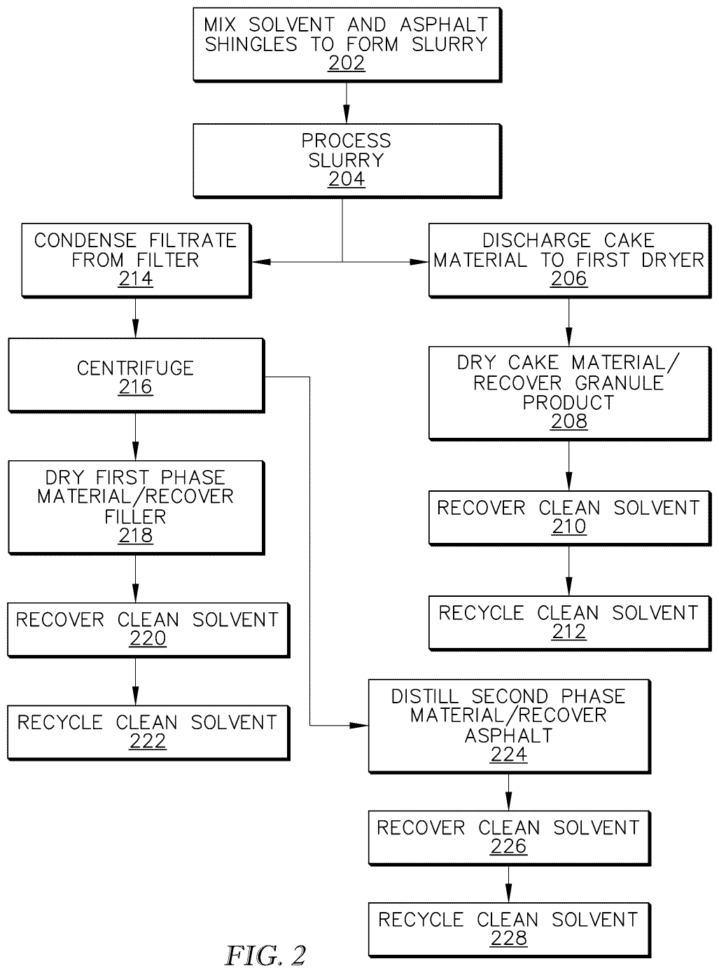

Referring now to FIGS. 1A and 2, in this exemplary implementation, the solvent is provided to the mixer 20 from the tank 12 via a pump 13. Pumps that can be utilized as pump 13 are known within the art and readily available. Unlike systems of known construction and known asphalt processing methodologies that utilize water in the processing of asphalt, in this exemplary embodiment and implementation, a non-water-based solvent is utilized to dissolve the asphalt shingles, which again, in this implementation, are in the form of asphalt granules. Accordingly, in some embodiments and implementations, the solvent does not include water. Indeed, unlike such known systems and methodologies, water is not placed in contact with either the asphalt granules or another solvent in the exemplary system 10 shown in FIGS. 1A and 1B and the exemplary method shown in FIG. 2. In this way, the exemplary system 10 and method of the present disclosure serves to eliminate or significantly reduce the formation of water-based emulsions that render asphalt recovery difficult and expensive.

A variety of solvents can be mixed with the asphalt granules in the mixer 20 to produce the solvent-asphalt shingle slurry. In this regard, and in some embodiments and implementations, the solvent mixed with the asphalt granules is an aromatic solvent that consists of one or more aromatic compounds. Aromatic compounds that can be used in the aromatic solvent include: benzonitrile, phenol, toluene, benzoic acid, benzaldehyde, acetophenone, styrene, anisole, aniline, benzenesulfonic acid, o-xylene, mesitylene, and combinations thereof.

In some embodiments and implementations, the solvent can be a petroleum-based solvent, such as diesel fuel.

In some embodiments and implementations, the solvent mixed with the asphalt granules is a terpene solvent that consists of one or more terpenes. In various embodiments and implementations, the one or more terpenes of the terpene solvent can include one or more monoterpenes, one or more sesquiterpenes, one or more diterpenes, or combinations thereof. In some embodiments and implementations, the terpene is selected from the group consisting of: citral; carvone; pulegone; citronellal; α-terpinene; β-terpinene; γ-terpinene; α-pinene; β-pinene; limonene; p-cymene; farnesene; sabinene; geraniol; β-citronellol; linayl acetate; 3-carene; 4-carene; 1,8-cineole; terpinene-4-ol; menthol, p-hydroquinone; myrtenal; carvacryl acetate; germacene; camphor; camphene; caryophyllene; γ-cadinene; nerol acetate; nerol; borneol; bornyl acetate; α-thujone; fenchone; estragole; verbenol; β-ociemene; geranial; geranyl acetate; camporene; chavicol; thujene; α-bisabolol; α-phellandrene; β-phellandrene; linalool; β-myrcene; carvacrol; terpinolene; eugenol; terpineol; menthone; anethole; nerolidol; cuminaldehyde; isopulegol; and combinations thereof.

In some embodiments and implementations, the solvent mixed with the asphalt granules is a renewable, bio-derived hydrocarbon solvent, which can also be characterized as a biodiesel solvent. In some embodiments and implementations, the biodiesel solvent consists of one or more mono-alkyl ester hydrocarbon solvent (which are also commonly referred to as fatty acid esters or fatty esters). Mono-alkyl esters have the general formula of:

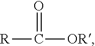

where R is alkyl or aryl, and R′ is alkyl. Mono-alkyl esters which can be utilized in the biodiesel solvent include methyl esters, mixed methyl esters, ethyl esters, and propyl esters. Methyl esters which can be utilized include, by way of non-limiting example, oleic acid, linoleic acid, linolenic acid, and biodiesel B-100 manufactured by Louis Dreyfus Company Agricultural Industries of Claypool, Indiana. Mixed methyl esters which can be utilized include, by way of non-limiting example, those derived from fatty acids (e.g., frying oils containing animal fats and/or assortment vegetable oils), such as FutureSol® MME, manufactured by FutureFuel Corp. of Clayton, Missouri or Chemical Abstracts Services (CAS) registry number 67762-38-3. Ethyl esters which can be utilized include, by way of non-limiting example, fatty acid ethyl esters derived from fish oil, such as Chemical Abstracts Services (CAS) registry number 91051-07-9, manufactured by Wiley Companies of Coshocton, Ohio.

In some embodiments and implementations, the solvent consists of one or more long-chain mono-alkyl esters. In some embodiments and implementations, some or all of the one or more mono-alkyl esters making up the biodiesel solvent that is mixed with the asphalt granules include a hydrocarbon R group that includes 16 to 18 carbon atoms, where the hydrocarbon R group includes 1 to 3 double bonds. Mono-alkyl esters of such composition are believed to be particularly useful in dissolving aromatic compounds present in asphalt (bitumen). In some embodiments and implementations, the one or more mono-alkyl esters of the biodiesel solvent includes one or more fatty acid amines.

In some embodiments and implementations, the solvent mixed with the asphalt granules in step 202 of the exemplary method shown in FIG. 2 is a blend of multiple solvents (or solvent blend) that includes a combination of two or more of: (i) an aromatic solvent consistent with that described above; (ii) a petroleum-based solvent consistent with that described above; (iii) a terpene solvent consistent with that described above, and (iv) a biodiesel solvent consistent with that described above.

For instance, in some embodiments and implementations, the solvent includes limonene (an aromatic solvent) and a biodiesel solvent including one or more mono-alkyl esters. In one such embodiment and implementation, the solvent includes limonene (e.g., Chemical Abstracts Services (CAS) registry number 5989-27-5) and biodiesel B-100 manufactured by Louis Dreyfus Company Agricultural Industries of Claypool, Indiana in a ratio of 1:99 wt %.

In another embodiment and implementation, the solvent includes limonene (e.g., Chemical Abstracts Services (CAS) registry number 5989-27-5).

In some embodiments and implementations, in addition to limonene and biodiesel, the solvent further includes diesel (e.g., Chemical Abstracts Services (CAS) registry number 68334-30-5). In one such embodiment and implementation, the solvent includes limonene, a biodiesel solvent including one or more mono-alkyl esters, and diesel in a ratio of 1:10:89 wt %.

In some embodiments and implementations, the solvent includes limonene and FutureSol® MME, manufactured by FutureFuel Corp. of Clayton, Missouri in a ratio of 1:99 wt %.

Accordingly, as reflected in the above examples, the solvent mixed with the asphalt granules may be derived, in whole or in part, from vegetable oils, animal fats, or fossil fuels.

It has been discovered that while mono-alkyl esters are an effective solvent for bitumen, a synergistic effect that improves the rate at which bitumen is dissolved and stripped can be realized by utilizing a solvent that contains mono-alkyl esters and in combination with monoterpenes. Monoterpenes are hydrocarbons that contain 10 carbon atoms and are, without wishing to be bound by theory, believed to be particularly useful in dissolving aliphatic compounds present in bitumen. Accordingly, in some embodiments and implementations, the solvent mixed with the asphalt granules in the mixer 20 includes one or more mono-alkyl esters and one or more monoterpenes.

In some embodiments and implementations, the solvent consists of a combination of 0.1 wt % monoterpenes, 0.1 wt % methyl esters, and 98.9 wt % diesel. In some embodiments and implementations, the solvent formed by such combination is heated to about 120° F. to about 130° F. to facilitate dissolution of the asphalt shingles during mixing. It has been discovered that, when the solvent formed by such combination is heated to the foregoing temperature range during mixing, the dissolution of the asphalt shingles is equivalent to that of limonene at about 70° F. to about 80° F. This finding is significant as mono-alkyl esters are generally more readily available and less expensive than monoterpenes. Monoterpenes utilized in the solvent can, in various embodiments, be renewable, bio-derived (i.e., sourced from a living organism), and/or biodegradable. In some embodiments and implementations, the solvent mixed with the asphalt granules in the mixer 20 includes one or more mono-alkyl esters, one or more monoterpenes, and diesel fuel.

Referring now again to FIGS. 1A and 2, in this exemplary implementation, the solvent-asphalt shingle slurry generated by the mixer 20 is fed to the filter 30 for processing, as indicated by step 204 in FIG. 2. In this exemplary implementation, the filter 30 processes the solvent-asphalt shingle slurry by washing, drying, and recovering a cake material from the solvent-asphalt shingle slurry. The recovered cake material is a granule slurry that includes the solvent and granules. The granules within the cake material, can include limestone, glass, and/or minerals.

Referring still to FIGS. 1A and 2, the cake material recovered by the filter 30 is subsequently discharged to the first dryer 40 for subsequent processing, as indicated by step 206 in FIG. 2. Once received by the first dryer 40, the cake material is heated and dried to isolate and recover the solid granules (or granule product) within the cake material, as indicated by step 208 of FIG. 2. The isolated solid granules can then be directed from the first dryer 40 to a collection receptacle 14 of the system 10 for subsequent use. The solid granules collected can include limestone, glass, and/or minerals from the asphalt shingles. In some implementations, the solid granules may be further classified into various sizes as required to meet end user requirements. In some implementations, the solid granules may be further refined to reduce the residual organic impurities to meet end user requirements.

Referring still to FIGS. 1A and 2, the vapor generated by heating and drying the cake material is directed to the first solvent recovery subsystem 80 where it is processed to recover the solvent present within the vapor, as indicated by step 210 in FIG. 2. In this regard, the vapor received by the first solvent recovery subsystem 80 is condensed by the condenser 82 to place the solvent within the vapor in a liquid state. Excess vapor which is not condensed is, in this exemplary implementation, discharged as exhaust by the second pump 86 of the first solvent recovery subsystem 80. The solvent resulting from condensing the vapor received from the first dryer 40 is substantially free of non-solvent material (e.g., limestone or bitumen particulate), and thus consistent with the solvent initially fed to the mixer 20. The clean solvent resulting from condensing the vapor received by the first dryer 40 is pumped by the first pump 84 of the first solvent recovery subsystem 80 to the tank 12 supplying the mixer 20 with solvent, as indicated by step 212 in FIG. 2 and streams 2 and 15 in FIG. 1A. In other words, in this exemplary implementation, the solvent recovered from the vapor is recycled and reused in the system 10.

Referring still to FIGS. 1A and 2, the processing of the solvent-asphalt shingle slurry by the filter 30 generates a filtrate. In this exemplary implementation, the filtrate generated by operation of the filter 30 includes solvent, asphalt, and limestone filler. The filtrate is directed to the filter recovery subsystem 90 where it is condensed, as indicated by step 214 in FIG. 2. In this regard, the filtrate received by the filter recovery subsystem 90 is condensed by the condenser 92 to place the filtrate in a liquid state. Excess filtrate which is not condensed is, in this exemplary implementation, discharged as exhaust by the second pump 96 of the filter recovery subsystem 90. The liquid filtrate resulting from condensing the vapor received from the filter 30 is pumped by the first pump 94 to the centrifuge 50 for further processing, and includes, in this exemplary implementation, solvent, asphalt, and limestone.

Referring still to FIGS. 1A and 2, the solvent derived from the filtrate of the filter 30 and received by the centrifuge 50 is spun by the centrifuge 50 to produce a first phase material and a second phase material, as indicated by step 216 in FIG. 2. The use of a non-polar solvent during step 202 to dissolve the asphalt granules is advantageous with respect to the downstream phase separation of the filtrate by the centrifuge 50 as it facilitates phase separation by the centrifuge 50 without the use of a polar solvent, such as water, which in combination with asphalt or a non-polar solvent, is apt to produce emulsions which make recovery of bitumen difficult. Accordingly, in some embodiments and implementations, the solvent mixed with the asphalt granules in the mixer 20 is a non-polar solvent.

Referring now to FIGS. 1B and 2, in this exemplary implementation, the first phase material from the filtrate includes a mixture of limestone filler and solvent, and the second phase material from the filtrate includes a mixture of asphalt and solvent. As indicated by step 218 in FIG. 2, the first phase material is discharged to the second dryer 60 for subsequent processing. Once received by the second dryer 60, the first phase material is heated and dried to isolate the limestone filler present within the first phase material. The isolated limestone filler can then be directed from the second dryer 60 to a collection receptacle 16 for later use, as indicated by stream 16 in FIG. 1B. In some implementations, the limestone filler may be classified into various sizes as required to meet end user requirements. In some implementations, the limestone filler may be further refined to reduce the residual organic impurities to meet end user requirements. In some implementations, the method further includes processing, by the cyclone separator 120, exhaust received from the second dryer 60 to isolate and recover additional limestone filler. In one such implementation, the method further includes processing, by the baghouse 130, exhaust received from the cyclone separator 120 to isolate and recover additional limestone filler.

Referring still to FIGS. 1B and 2, in this exemplary implementation, the vapor generated by the processing of the first phase material is, in this exemplary embodiment, processed to recover clean solvent, as indicated by step 220 in FIG. 2. Specifically, in this exemplary implementation, exhaust from the processing of the first phase material is directed from the baghouse 130 to the second solvent recovery subsystem 100 where it is condensed to recover clean solvent in the same manner as described above for the first solvent recovery subsystem 80. The clean solvent resulting from condensing the vapor is pumped by the first pump 104 of the second solvent recovery subsystem 100 to the tank 12 for reuse within the system 10, as indicated by step 222 in FIG. 2. In alternative embodiments and implementations, exhaust from the second dryer 60 and/or the cyclone separator 120 can be directed to the second solvent recovery subsystem 100 to recover solvent.

Although the exemplary method is primarily described herein as involving the separate drying of the solid granules within the cake material and the limestone filler, alternative embodiments and implementations are also contemplated in which the solid granules within the cake material and the limestone filler within the second phase material are dried together, e.g., in the second dryer 60. In such embodiments and implementations, the dried solids resulting from drying the solid granules of the cake material and the limestone filler collectively may be classified into various sizes as required for end use.

Referring now to FIGS. 1A, 1B, and 2, the second phase material is discharged from the centrifuge 50 to the distillation unit 70 for subsequent processing, as indicated by step 224 in FIG. 2 and stream 8 in FIG. 1B. Once received by the distillation unit 70, the second phase material is heated until the solvent is vaporized, thus leaving isolated asphalt behind. In some implementations, the second phase material can be processed by the distillation unit 70 in a similar fashion as the processing of bitumen-infused solvent by the distillation tank described in U.S. Patent Application Publication No. 2023/0313045, which is incorporated herein by reference in its entirety. The isolated asphalt can then be directed from the distillation unit 70 to a collection receptacle 18 for later use, as indicated by stream 10 in FIG. 1B. In some implementations, the isolated asphalt collected in the collection receptacle 18 can be deposited into a vehicle for transporting the isolated asphalt to an intended destination. In this exemplary embodiment, the vapor generated by vaporizing the solvent present in the second phase material is directed to the third solvent recovery subsystem 110 where it is condensed to recover clean solvent in the same manner as described above for the first solvent recovery subsystem 80 and the second solvent recovery subsystem 100, as indicated by step 226 in FIG. 2 and stream 9 in FIG. 1B. The clean solvent resulting from condensing the vapor received by the distillation unit 70 is pumped by the first pump 114 of the third solvent recovery subsystem 110 to the tank 12 for reuse within the system 10, as indicated by step 228 in FIG. 2.

As evidenced in the above discussion, the solvent utilized during the operation of the various components of the system 10 and execution of the various steps of the method disclosed herein is processed and recycled back to the tank 12 responsible for supplying the mixer 20. As such, the system 10 can be characterized as employing a closed loop solvent subsystem. As further evidenced in the above discussion, the first solvent recovery subsystem 80, the second solvent recovery subsystem 100, and the third solvent recovery subsystem 110 facilitate the recovery of clean solvent without the use of water.

Referring now again to FIGS. 1A, 1B, and 2, in some implementations, the solvent and asphalt shingles are continuously fed to the mixer and the operations of the system 10 components described above continuously carried out to provide continuous isolation and extraction of asphalt, solid granules, and limestone filler from asphalt shingles, instead of isolating such constituents in discrete batches. In other words, the exemplary system 10 and method can, in some embodiments and implementations, provide continuous isolation and recovery of asphalt, solid granules, and limestone filler from asphalt shingles.

Although the system 10 is primarily described above as including a filter 30 and a filter recovery subsystem 90 that process the solvent-asphalt shingle slurry produced by the mixer 20 prior to being received by the centrifuge 50, alternative embodiments in which the solvent-asphalt shingle slurry produced by the mixer 20 is directed to the centrifuge 50 for processing, without pre-processing by the filter 30 and filter recovery subsystem 90 are also contemplated herein. In some alternative implementations, the solvent-asphalt shingle slurry produced and directed out of the mixer 50 is not subjected to any pre-processing prior to being received by the centrifuge 50. In some alternative implementations, slurry produced by the mixer 20 is directed directly from the mixer 20 to the centrifuge 50. Accordingly, in some alternative embodiments, the filter 30 and the filter recovery subsystem 90 is omitted from the system 10. In some alternative embodiments, the first dryer 40 and the first solvent recovery subsystem 80 may also be omitted from the system 10.

Additionally, although the exemplary method for recovering bitumen, granules, and limestone fillers from used asphalt shingles (in whole or in part) is primarily described herein as including the steps of processing the solvent-asphalt shingle slurry to produce a cake material and a filtrate, and drying the cake material to isolate granules within the asphalt shingles, alternative implementations, in which such steps are omitted are also contemplated herein. In various alternative implementations, the solvent-asphalt shingle slurry can be processed by centrifuge, without pre-processing of the solvent-asphalt shingle slurry by a filter or filter recovery subsystem. Accordingly, in alternative implementations of the method, the method comprises the steps of: (a) mixing a solvent and the asphalt shingles to produce a slurry; (b) centrifuging the slurry to produce a first phase material including limestone filler and a second phase material including bitumen, where the slurry is not pre-processed by a filter; (c) drying the first phase material to recover the limestone filler; and (d) distilling the second phase material to recover the bitumen. In some alternative implementations, the slurry is not pre-processed at all prior to being subject to centrifuging. Accordingly, in some alternative implementations, slurry produced by the mixer 20 is directed directly from the mixer 20 to the centrifuge 50.

One of ordinary skill in the art will recognize that additional embodiments and implementations are also possible without departing from the teachings of the present disclosure. This detailed description, and particularly the specific details of the exemplary embodiments and implementations disclosed herein, are given primarily for clarity of understanding, and no unnecessary limitations are to be understood therefrom, for modifications will become obvious to those skilled in the art upon reading this disclosure and may be made without departing from the spirit or scope of the disclosure.

What is claimed is:

1. A system for recovering constituents of asphalt shingles, comprising:
a mixer configured to receive and mix the asphalt shingles and a solvent to produce a slurry;
a filter configured to receive and process the slurry to generate a cake material and a filtrate;
a first dryer configured to receive and heat the cake material to isolate a first constituent of the asphalt shingles;
a centrifuge configured to receive and separate the filtrate into a first phase material and a second phase material;
a second dryer configured to receive and heat the first phase material to isolate a second constituent of the asphalt shingles; and
a distillation unit configured to receive and process the second phase material to isolate a third constituent of the asphalt shingles.

2. The system of claim 1, and further comprising:
one or more solvent recovery subsystems configured to recover the solvent from the first dryer, the distillation unit, the second dryer, or another component of the system that in fluid communication with, and positioned downstream of, the second dryer.

3. The system of claim 2, wherein the one or more solvent recovery subsystems includes
a first solvent recovery subsystem that is in fluid communication with the first dryer,
a second solvent recovery subsystem in fluid communication with a baghouse that is in fluid communication with the second dryer and configured to isolate the second constituent from received exhaust, and
a third solvent recovery subsystem that is in fluid communication with the distillation unit, and
wherein each of the first solvent recovery subsystem, the second solvent recovery subsystem, and the third solvent recovery subsystem includes (i) a condenser for condensing vapor to a liquid state, and (ii) a pump for pumping liquid received from the condenser.

4. The system of claim 3, wherein the baghouse is in fluid communication with a cyclone separator that is in fluid communication with the second dryer.

5. The system of claim 1, wherein the filter and the centrifuge are in fluid communication with one another via a filter recovery subsystem, the filter recovery subsystem including (i) a condenser to condense the filtrate to a liquid state, and (ii) a pump to pump the filtrate in the liquid state to the centrifuge.

6. The system of claim 1, wherein the centrifuge comprises multiple centrifuges.

7. The system of claim 6, wherein the centrifuge comprises a decanter centrifuge and a disc-stack centrifuge that is in fluid communication with the decanter centrifuge.

8. The system of claim 1, wherein the first constituent of the asphalt shingles is granules from the asphalt shingles, the second constituent of the asphalt shingles is limestone filler from the asphalt shingles, and the third constituent of the asphalt shingles is bitumen from the asphalt shingles.

9. The system of claim 1, wherein the system further includes:
a solvent tank in fluid communication with the mixer, the solvent tank containing recovered solvent recovered by a solvent recovery subsystem of the system, and wherein the recovered solvent is an aromatic solvent, a petroleum-based solvent, a terpene solvent, a biodiesel solvent, or combinations thereof.

10. The system of claim 9, wherein the recovered solvent is a solvent blend including two or more of the aromatic solvent, the petroleum-based solvent, the terpene solvent, and the biodiesel solvent.

11. The system of claim 9, wherein the recovered solvent includes one or more mono-alkyl esters and one or more monoterpenes.

12. The system of claim 9, wherein the recovered solvent is non-polar.

13. The system of claim 9, wherein the recovered solvent includes one or more fatty acid amines.

14. The system of claim 1, wherein the mixer is an acoustic mixer.

15. A system for recovering bitumen, granules, and limestone filler from asphalt shingles, comprising:
a mixer configured to receive and mix the asphalt shingles and a solvent to produce a slurry;
a filter configured to receive and process the slurry to generate a cake material and a filtrate;
a first dryer configured to receive and heat the cake material to isolate the granules of the asphalt shingles;
a centrifuge configured to receive and separate the filtrate into a first phase material and a second phase material;
a second dryer configured to receive and heat the first phase material to isolate the limestone filler of the asphalt shingles; and
a distillation unit configured to receive and process the second phase material to isolate the bitumen of the asphalt shingles.

16. A method for recovering bitumen, granules, and limestone filler from asphalt shingles, the method comprising steps of:
mixing a solvent and the asphalt shingles to produce a slurry;
processing the slurry to produce a cake material and a filtrate;
drying the cake material to isolate granules within the asphalt shingles;
centrifuging the filtrate to produce a first phase material including limestone filler and a second phase material including bitumen;
drying the first phase material to isolate the limestone filler; and
distilling the second phase material to isolate the bitumen.

17. The method of claim 16, wherein the asphalt shingles are in granular form.

18. The method of claim 16, and further comprising a step of:
recovering at least one of solvent present in the cake material, solvent present in the first phase material, and solvent present in the second phase material.

19. The method of claim 18, and further comprising a step of:
recirculating the at least one of solvent present in the cake material, solvent present in the first phase material, and solvent present in the second phase material to a mixer from which the slurry was produced.

20. The method of claim 16, wherein centrifuging the filtrate includes substeps of (i) centrifuging, by a first centrifuge, the filtrate, and (ii) centrifuging, by a second centrifuge, liquid received from the first centrifuge.

21. The method of claim 16, wherein the solvent is an aromatic solvent, a petroleum-based solvent, a terpene solvent, a biodiesel solvent, or combinations thereof.

22. The method of claim 21, wherein the solvent is a solvent blend including two or more of the aromatic solvent, the petroleum-based solvent, the terpene solvent, and the biodiesel solvent.

23. The method of claim 16, wherein the solvent includes one or more mono-alkyl esters and one or more monoterpenes.

24. The method of claim 16, wherein the solvent is non-polar.

25. The method of claim 16, wherein the solvent includes one or more fatty acid amines.

26. A system for recovering constituents of asphalt shingles, comprising:
a mixer configured to receive and mix the asphalt shingles and a solvent to produce a slurry;
a centrifuge configured to receive and separate the slurry into a first phase material and a second phase material;
a dryer configured to receive and heat the first phase material to recover a first constituent of the asphalt shingles; and
a distillation unit configured to receive and process the second phase material to recover a second constituent of the asphalt shingles.

27. The system of claim 26, wherein the first constituent is limestone filler, and the second constituent is bitumen.
